(19) United States
(12) Patent Application Publication
(10) Pub. No.: US 2017/0171119 A1
(43) Pub. Date: Jun. 15, 2017

(54) SYSTEMS AND METHODS FOR ACTIVE INDEXATION

(71) Applicant: Hattar Tanin LLC, Novato, CA (US)

(72) Inventors: Saadeh HATTAR, Novato, CA (US); Volodymyr Tanin, Kiev (UA)

(21) Appl. No.: 15/379,379

(22) Filed: Dec. 14, 2016

Related U.S. Application Data
(60) Provisional application No. 62/266,828, filed on Dec. 14, 2015.

(51) Int. Cl. H04L 12/58; H04L 29/08

(52) U.S. Cl. CPC H04L 51/04; H04L 67/306; H04L 67/02; H04L 67/22

(57) ABSTRACT

The disclosure provides systems and methods to more efficiently index content available over the Internet. In some aspects, the methods and systems described herein accomplish this by actively providing notification to a search engine after creating a new webpage or updating an existing webpage. The disclosure also provides systems and methods for more convenient handling with updates and messages originated from various disparate sources.

### CROSS REFERENCE TO RELATED APPLICATIONS

This application claims priority to U.S. Provisional Patent Application No. 62/266,828, entitled “Active Indexation and United Window Technologies for Internet Communications,” filed Dec. 14, 2015, which is hereby incorporated by reference.

### TECHNICAL FIELD

This specification describes technologies relating to methods, systems, and software for indexing websites and concurrently displaying information from multiple sources.

### BACKGROUND

The growing number of websites and services available over the Internet makes it difficult for users to keep track of all of their accounts, news feeds, and other frequently visited web sites.

In addition, current methods for indexing websites rely on passive mechanisms. After creating a new website, or updating an existing website, the host must wait until search engines crawl the website and then index the available content on the website, before their newly posted content is accessible by searching the Internet. Moreover, these passive web crawling and indexing methods are increasingly resource-intensive for search engines, as the amount of information available over the Internet continues to grow.

Accordingly, improved systems and methods are needed for displaying aggregated content and for more efficiently indexing content available over the Internet.

### SUMMARY

The present disclosure addresses these and other needs for systems and methods to display aggregated content. In some aspects, the methods and systems described herein accomplish this by displaying content from a plurality of communication channels, e.g., e-mail accounts, news channels, social networks, link services, messengers, video services, updates from selected sites, in a single user interface. In this fashion, the user receives notifications, e-mails, new feeds, and/or any other desired content in a single place. This user interface also allows the user to communicate via one or more of the communication channels displayed through a unified user interface. For example, when the user receives an e-mail (and/or other message or update) from one of his e-mail accounts, the user can read the email, access attached files, and respond to the email, from the single, unified user interface.

The present disclosure also addresses these and other needs for systems and methods to more efficiently index content available over the Internet. In some aspects, the methods and systems described herein accomplish this by actively providing notification to a search engine after creating a new webpage or updating an existing webpage. Advantageously, this significantly reduces the lag period between creating or updating a website and making new content accessible to the public through Internet search engines.

In one aspect, the disclosure provides methods and systems for maintaining an index of a plurality of websites, where each respective website in the plurality of websites includes one or more webpages. The method is performed on a computer system having one or more processors and memory storing one or more programs for execution by the one or more processors. The method includes storing sitemap information for the plurality of websites, where the sitemap information includes a predicted update period and/or identification of update time for each respective website in the plurality of websites identified by the sitemap information. The method also includes storing index information for each website in the plurality of websites in an index data store, where, a first website in the plurality of websites is hosted by an external system, the first website includes a plurality of inter-referenced webpages, and the index information includes an index of the first website that includes an index of each webpage in the plurality of inter-referenced webpages. Responsive to an update of at least one webpage in the plurality of inter-referenced webpages of the first website by the external system, the method includes receiving an update to the index of the entire first website from the external system, where the update to the index is made by the external system and where the update to the index takes into account the update to the at least one webpage, and updating the stored sitemap information to identify each webpage in the plurality of inter-referenced webpages of the first website as current. The method also includes analyzing the stored sitemap information to identify a webpage of a website in the plurality of websites as having index information in the index data store that is at least potentially out of date, and scheduling webpages for crawling in accordance with the analyzing of the stored sitemap information.

In some embodiments, the sitemap information includes a predicted update period for each respective webpage of each respective website in the plurality of websites identified by the sitemap information.

In some embodiments, where the sitemap information includes last modification dates for at least a subset of websites, at least some of the webpages scheduled for crawling are scheduled in accordance with the last modification dates of their corresponding websites.

In one aspect, the disclosure provides methods and systems for maintaining an index of a plurality of websites, where each respective website in the plurality of websites includes one or more webpages. The method is performed on a computer system having one or more processors and memory storing one or more programs for execution by the one or more processors. The method includes storing sitemap information for the plurality of websites, where the sitemap information includes a predicted update period for each respective website in the plurality of websites identified by the sitemap information. The method also includes storing index information for each website in the plurality of websites in an index data store, where, a first website in the plurality of websites is hosted by an external system, the first website includes a plurality of inter-referenced webpages, and the index information includes an index of the first website that includes an index of each webpage in the plurality of inter-referenced webpages. Responsive to an update of at least one webpage in the plurality of inter-referenced webpages of the first website by the external system, the method includes receiving an update request to index the website from the external system, where the request to index identifies a subset of webpages in the plurality of inter-referenced webpages that have been updated, and updating the stored sitemap information to identify each of the webpages in the subset of webpages of the first website that have been updated as not current. The method also includes analyzing the stored sitemap information to identify a respective webpage of a website in the plurality of websites that has index information in the index data store that is at least potentially out of date (e.g., indicating that the respective webpage has been modified) where the analyzing selects the subset of webpages in the first website that have been updated, and scheduling webpages for crawling in accordance with the analyzing of the stored sitemap information.

In some embodiments, the sitemap information includes a predicted update period for each respective webpage of each respective website in the plurality of websites identified by the sitemap information.

In some embodiments, where the sitemap information includes last modification dates for at least a subset of websites, at least some of the webpages scheduled for crawling are scheduled in accordance with the last modification dates of their corresponding websites.

In one aspect, the disclosure provides methods and systems for maintaining an index of a website, where the website includes a plurality of inter-referenced webpages. The method is performed on a computer system having one or more processors and memory storing one or more programs for execution by the one or more processors. The method includes updating at least one webpage in the plurality of inter-referenced webpages of the website. The method also includes indexing, responsive to the updating, the entire first website, where the indexing takes into account the update to the at least one webpage and where the indexing is performed by a curator of the first website. The method further includes communicating the index to a remote system responsible for indexing a plurality of websites that is not associated with the curator.

In some embodiments, the indexing forms a current index for the website. In some embodiments, the indexing further includes comparing data of a prior indexing of the website to the current index of the website thereby identifying one or more subsets of the current index that are different as compared to the prior indexing, the one or more subsets of the current index corresponding to the at least one webpage that has been updated. In some embodiments, the communicating the index communicates just those portions of the current index which got changed to the remote system responsible for indexing the plurality of websites.

In one aspect, the disclosure provides methods and systems for maintaining an index of a website, where the website comprises a plurality of inter-referenced webpages. The method is performed on a computer system having one or more processors and memory storing one or more programs for execution by the one or more processors. The method includes updating a component of at least one webpage in the plurality of inter-referenced webpages of the website. The method also includes determining, responsive to the updating, which webpages in the plurality of inter-referenced webpages are modified by the updating of the component, where the webpages in the plurality of inter-referenced webpages that are modified by the updating of the component constitute a subset of the webpages in the plurality of inter-referenced webpages. The method further includes communicating a request to index to a remote system responsible for indexing a plurality of websites, where the request to index includes a request to index each webpage in the subset of webpages and does not include a request to index webpages in the plurality of inter-referenced webpages that are not in the subset of webpages (e.g., a request to index only those webpages that have been updated).

### BRIEF DESCRIPTION OF THE DRAWINGS

The implementations disclosed herein are illustrated by way of example, and not by way of limitation, in the figures of the accompanying drawings. Like reference numerals refer to corresponding parts throughout the drawings.

FIG. 1 illustrates an exemplary use interface for displaying aggregated content, in accordance with some implementations.

FIG. 2 illustrates an exemplary topology for web crawling.

### DETAILED DESCRIPTION

Reference will now be made in detail to implementations of the present application as illustrated in the accompanying drawings. The same reference indicators will be used throughout the drawings and the following detailed description to refer to the same or like parts. Those of ordinary skill in the art will realize that the following detailed description of the present application is illustrative only and is not intended to be in any way limiting. Other embodiments of the present application will readily suggest themselves to such skilled persons having benefit of this disclosure.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In one aspect, the disclosure describes methods and systems for displaying a user interface that displays content aggregated from a plurality of sources in a single window. All user communication channels which include, but are not limited to, e-mail boxes, news channels, social networks, link services, messengers, video transmission/holding services, updates from selected sites etc. are presented in a convenient way in one window. The user gets notification about any changes (incoming messages) in the united window. User is able to carry out all incoming and/or outgoing interactions, as if he using separate client for each information/communication source/channel, but also he is able to combine that together, using all benefits of combined usage. For example, he is able to use several accounts in several link services/messengers to realize any communication, to organize group conferences. For example, user is able to send post to/upload information to any/specified number of his available accounts in specified/any service(s). If the user receives message of any type, like e-mail (and/or any other type(s) of message and/or update) from one of his e-mail accounts (boxes)/other resource(s)/service(s) account(s), he is able to read the email/message/information, extract all attached files (if they are) and respond from receiver-account(s) or from any other of his account(s). User can choose to make visible only messages/updates just from all and/or specified e-mail boxes and/or news channels, and/or social networks, and/or link services, and/or messengers, and/or video transmission/holding services. Any other variants of user-resource/user-service interactions are also possible.

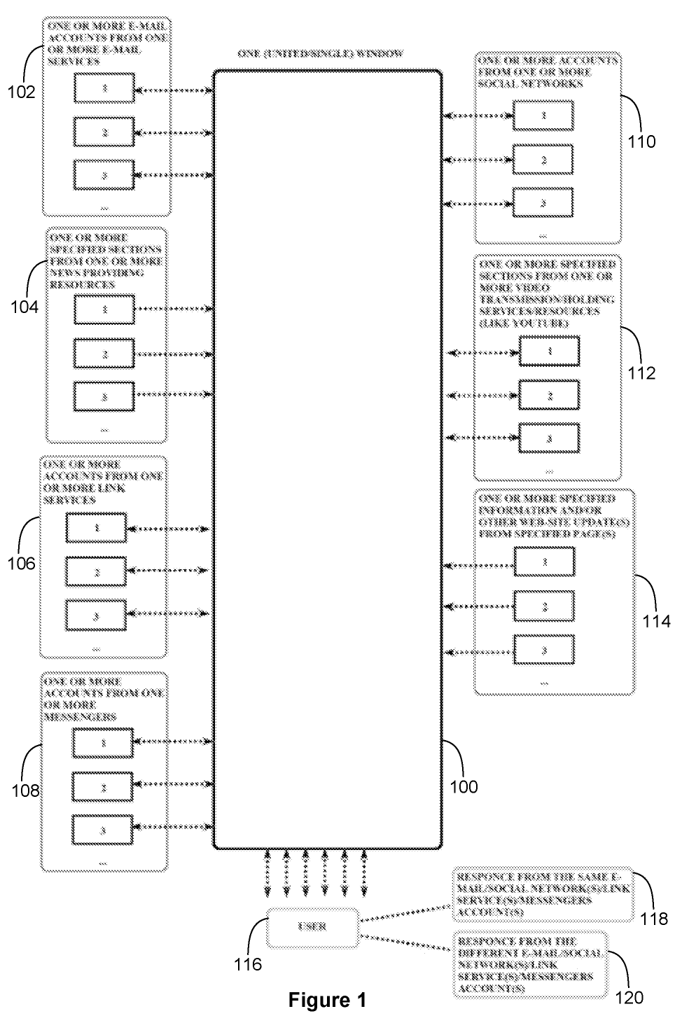

Referring to FIG. 1, an exemplary united user interface 100 displays emails aggregated from one or more email accounts 102 (e.g., Gmail, Hotmail, Webmail, etc.), updates from news sites 104 (e.g., CNN, MSNBC, BBC, etc.), content and/or account information from or more communication linking services 106 (e.g., Vibe, WhatsApp, FaceTime, etc.), messages and/or account information from one or more messaging services 108 (e.g., iMessages, Instant Messenger, etc.), content and/or account information from one or more social networking services 110 (e.g., Facebook, SnapChat, Twitter, etc.), content from one or more video hosting websites 112 (e.g., YouTube, Hulu, etc.), and updates from one or more user-specified websites 114 (e.g., Sportslllustrated, ESPN, etc.).

In some embodiments, the user can interact with the content displayed within the unified user interface. For example, by sending a reply 118 to email 1 of the aggregated emails through the email service from which email 1 was received (e.g., sending a reply to a message received through Gmail back through Gmail), or by sending a reply 120 to email 1 of the aggregated emails through a different email service from which email 1 was received (e.g., sending a reply to a message received through Gmail back through Hotmail).

In one aspect, the disclosure describes methods and systems for aggregating and displaying emails from a plurality of email accounts (e.g., from one or more email services) in a single user interface. This is accomplished without downloading emails, where email messages from the plurality of email accounts are ordered according to their incoming date and time, or according to the email address of the senders. The user can read the email, extract all attached files, and respond via the account through which the email was received, or through any of the other email accounts linked to the unified user interface. In some embodiments, the methods and systems described herein for aggregating and displaying emails also categorize emails received from a plurality of email accounts together (e.g., by grouping received emails, sent emails, spam emails, emails received by pre-specified senders, etc.).

In some embodiments, the systems and methods described herein allow simultaneous (and/or at the same time, and/or in the mode of one/single and/or general, and/or mutual window, and/or in the mode of one/single and/or general, and/or mutual account, and/or in the mode of one/single and/or general, and/or mutual access, and/or as in one/single and/or general, and/or mutual account, and/or as in one/single and/or general, and/or mutual access, and/or as in one/single and/or general, and/or mutual window) or not—all (and/or selected, and/or specified) functions, which are provided to the owners of specified and/or different email accounts (and/or email boxes) by email service (and/or by email services), and/or also any other patent-pending functions, realization of which becomes possible and/or gets sense/value by/when using patent-pending function and/or patent-pending service of simultaneous (and/or at the same time, and/or in the mode of one/single and/or general, and/or mutual window, and/or in the mode of one/single and/or general, and/or mutual account, and/or in the mode of one/single and/or general, and/or mutual access, and/or as in one/single and/or general, and/or mutual account, and/or as in one/single and/or general, and/or mutual access, and/or as in one/single and/or general, and/or mutual window) display of email letters (and/or all letters, and/or selected letters, and/or specified letters) from different accounts (and/or email boxes) of one/single email service and/or of different email services in form of one/single list (and/or at the same time, and/or in the mode of one/single and/or general, and/or mutual window, and/or in the mode of one/single and/or general, and/or mutual account, and/or in the mode of one/single and/or general, and/or mutual access, and/or as in one/single and/or general, and/or mutual account, and/or as in one/single and/or general, and/or mutual access, and/or as in one/single and/or general, and/or mutual window).

In some embodiments, the systems and methods described herein allow display to which email box (and/or email account) this and/or that letter is referred in any formed (and/or assembled, and/or united, and/or created) list of letters.

In some embodiments, the systems and methods described herein allow response to an incoming letter (and/or letters) from that email box and/or email account (and/or email boxes and/or email accounts), to which this/these letter(s) was/were sent, and/or from any other email box and/or email account (and/or email boxes and/or email accounts), and/or using for this settings “by default” and/or manual mode of defining of email box and/or email account (and/or email boxes and/or email accounts).

In some embodiments, the systems and methods described herein allow simultaneous (and/or at the same time, and/or in the mode of one/single and/or general, and/or mutual window, and/or in the mode of one/single and/or general, and/or mutual account, and/or in the mode of one/single and/or general, and/or mutual access, and/or as in one/single and/or general, and/or mutual account, and/or as in one/single and/or general, and/or mutual access, and/or as in one/single and/or general, and/or mutual window) display of email letters (and/or all letters, and/or selected letters, and/or specified letters) from different accounts (and/or email boxes) of one/single email service and/or of different email services in form of one/single list (and/or at the same time, and/or in the mode of one/single and/or general, and/or mutual window, and/or in the mode of one/single and/or general, and/or mutual account, and/or in the mode of one/single and/or general, and/or mutual access, and/or as in one/single and/or general, and/or mutual account, and/or as in one/single and/or general, and/or mutual access, and/or as in one/single and/or general, and/or mutual window) without downloading letters (and/or without downloading all letters, and/or without downloading specified letters) are also considered and/or estimated, and/or assumed as patent-pending function and/or patent-pending functions, and/or patent-pending service, and/or patent-pending services.

One window services are based on permanent renewal of the information. Unfortunately existing search engines do not provide the information about changes “on the fly”; they need some time for exploring the Internet and indexation. It would be very helpful to combine one window technologies with the technology of instant indexation which can also work as a separate service of active indexation of Web sites.

The idea of our next innovation is that indexation of websites/website pages have to be carried out in the active way, because websites are, as a rule, created to share information. It is their main purpose and the key intention of its creators. It is understandable, that in case of provision of all/specified information on creation/modification/(any other changes) of any website page(s) on any website(s) by the website(s) itself/themselves will provide immediate /sharing/provision of this information. It will provide huge benefits to website owners and users, thanks to immediate information exchange, and also this will lower hugely the resources, which are necessary to search engine(s) to carry out indexation of websites/website pages.

In one aspect, the disclosure describes methods and systems for actively indexing new and updates websites. In some embodiments, this is achieved by methods and systems that send information on any new or updated content on the web page to one or more search engines. In some embodiments, this information includes, but is not limited to, information concerning created page(s)/content, concerning modified page(s)/content, concerning any deleted information and/or any other information/data. In some embodiments, the client device sends only information required to update the index of the search engine.

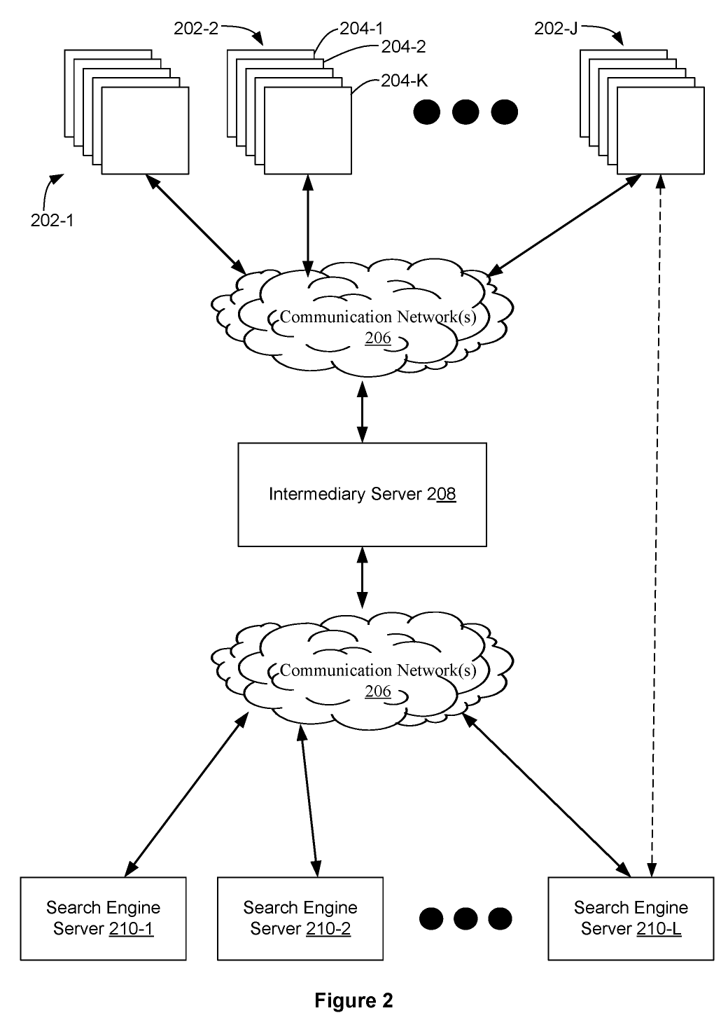

Referring to FIG. 2, many websites 202 are composed of multiple webpages 204, linked together on a client server. For example, website 202-2 includes webpages 204-1 through 204-K. In some embodiments, after a website 202 is created or updated, a client device or server associated with website 202 sends information about new content on the website to search engines 210, which use the information to update their indexing of the website. In some embodiments, the information is sent, via a communications network 206 (e.g., over the Internet), through an intermediary server 208, which then distributes the information to a plurality of search engines 210 (e.g., Google, Bing, Yahoo, etc.). In other embodiments, the client device or server hosting website 202 sends the information directly to one or more search engines (e.g., indexing information from website 202-J is sent directly to search engine 210-L).

In some embodiments, the client device or server hosting website 202 creates, or modifies an existing, index for the website and sends the entire index to one or more search engines 210 (e.g., directly or through intermediary server 208). In some embodiments, search engine 210 replaces an existing index for the website 202 with the new index sent from the website. In other embodiments, search engine 210 compares the index sent from the website 202 with an existing index and updates the existing index to reflect any differences from the index sent by the website.

In some embodiments, the client device or server hosting website 202 generates information about the updates to the website and sends only the updated information to the one or more search engines 210 (e.g., directly or through intermediary server 208). For example, if only webpages 204-1 and 204-K are updated on website 202-2, the client device or server hosting website 202-2 only sends search engine 210 about webpages 204-1 and 204-K (e.g., complete indexing information for these webpages or information about the changes on these webpages).

In some embodiments, the client device or server hosting website 202 only sends the one or more search engines 210 an indication that the website (and/or particular pages 204 within the website) has been updated. After receiving this information, search engine 210 schedules (or reschedules) crawling of the indicated website (and/or webpages), thereby reducing the lag between updating the webpage and indexing of the webpage by the search engine. Conventional methods for web crawling and indexing web sites are known in the art. More information on these methods is found, for example, in U.S. Pat. No. 7,308,643, the content of which is hereby incorporated by reference, in its entirety, for all purposes.

In some embodiments, the disclosure describes databases (e.g., intermediary servers) that receive updated indexing information from the client devices associated with the new or updated websites. In some embodiments, the intermediary server then sends the updated indexing information to a plurality of servers associated with different Internet search engines.

In some embodiments, the disclosure describes third party servers (e.g., associated with various Internet search engines) that receive updated indexing information (e.g., directly from a client device/webpage or through an intermediary server) and update their index for the website. In some embodiments, this is accomplished by receiving indexing information that is used directly to update existing indexing information for the client website. In other embodiments, this is accomplished by scheduling, or re-scheduling, crawling of the website with new or updated content.

In some embodiments, the disclosure describes methods and systems that integrate some or all of these components (e.g., client devices/websites, intermediary servers, and third party servers).

The methods and systems described herein improve the experience of using the Internet by reducing the time required to view content from a plurality of sources. The methods and systems described herein also improve the experience of using the Internet by reducing the lag time between website updates and indexing of the new content. This enables quicker access to new content on the Internet through search engines. This also reduces the resources required to refresh indexing of content available over the Internet.

### CONCLUDING REMARKS

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

Memory optionally includes high-speed random access memory and optionally also includes non-volatile memory, such as one or more magnetic disk storage devices, flash memory devices, or other non-volatile solid-state memory devices. Access to memory by other components of device, such as one or more processors and a peripherals interface, is, optionally, controlled by a memory controller.

A peripherals interface can be used to couple input and output peripherals of the device to one or more processors and memory. The one or more processors run or execute various software programs and/or sets of instructions stored in memory to perform various functions for device and to process data.

Each of the above identified modules and applications correspond to a set of executable instructions for performing one or more functions described above and the methods described in this application (e.g., computer-implemented methods). These modules (i.e., sets of instructions) need not be implemented as separate software programs, procedures or modules, and thus various subsets of these modules are, optionally, combined or otherwise re-arranged in various embodiments. In some embodiments, memory optionally stores a subset of the modules and data structures identified above. Furthermore, memory optionally stores additional modules and data structures not described above.

Accordingly, in other embodiments, the present disclosure provides electronic devices including one or more processors, memory, and optionally a display, where the memory includes instructions for performing all or a portion of one or more methods described herein. For example, electronic devices with instructions for performing only the portions of the disclosed methods associated with a first, second, third, etc., device are contemplated. E.g., in some embodiments, the electronic device includes instructions for performing steps associated with one or more of a client website, an intermediary server, or a third-party search engine server, as referred to in the methods disclosed herein.

In other embodiments, the present disclosure provides computer readable storage medium (e.g., non-transitory medium) storing one or more programs, the one or more programs including instructions, which when executed by an electronic device with one or more processors and optionally a display, cause the device to perform all or a portion of one or more methods described herein. For example, computer readable storage medium with instructions for performing only the portions of the disclosed methods associated with a first, second, third device, etc., device are contemplated. E.g., in some embodiments, the computer readable storage medium includes instructions for performing steps associated with one or more of a client website, an intermediary server, or a third-party search engine server, as referred to in the methods disclosed herein.

It will also be understood that, although the terms “first,” “second,” etc. may be used herein to describe various elements, these elements should not be limited by these terms. These terms are only used to distinguish one element from another. For example, a first object could be termed a second object, and, similarly, a second object could be termed a first object, without changing the meaning of the description, so long as all occurrences of the “first object” are renamed consistently and all occurrences of the “second object” are renamed consistently. The first object and the second object are both objects, but they are not the same object.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative implementations. For purposes of explanation, numerous specific details were set forth in order to provide an understanding of various implementations of the inventive subject matter. It will be evident, however, to those skilled in the art that implementations of the inventive subject matter may be practiced without these specific details. In general, well-known instruction instances, protocols, structures and techniques have not been shown in detail.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

What is claimed is:

1. A method of maintaining an index of a plurality of websites, each respective website in the plurality of websites comprising one or more webpages, the method performed on a computer system having one or more processors and memory storing one or more programs for execution by the one or more processors, the method comprising:
storing sitemap information for the plurality of websites, wherein the sitemap information includes a predicted update period for each respective website in the plurality of websites identified by the sitemap information;
storing index information for each website in the plurality of websites in an index data store, wherein,
a first website in the plurality of websites is hosted by an external system,
the first website comprises a plurality of inter-referenced webpages, and
the index information includes an index of the first website that comprises an index of each webpage in the plurality of inter-referenced webpages;
responsive to an update of at least one webpage in the plurality of inter-referenced webpages of the first website by the external system:
(a) receiving an update to the index of the entire first website from the external system, wherein the update to the index is made by the external system and wherein the update to the index takes into account the update to the at least one webpage, and
(b) updating the stored sitemap information to identify each webpage in the plurality of inter-referenced webpages of the first website as current;
analyzing the stored sitemap information to identify a webpage of a website in the plurality of websites as having index information in the index data store that is at least potentially out of date; and
scheduling webpages for crawling in accordance with the analyzing of the stored sitemap information.

2. The method of claim 1, wherein the sitemap information includes a predicted update period for each respective webpage of each respective website in the plurality of websites identified by the sitemap information.

3. The method of claim 1, wherein the sitemap information includes last modification dates for at least a subset of websites; and wherein at least some of the webpages scheduled for crawling are scheduled in accordance with the last modification dates of their corresponding websites.

4. A method of maintaining an index of a plurality of websites, each respective website in the plurality of websites comprising one or more webpages, the method performed on a computer system having one or more processors and memory storing one or more programs for execution by the one or more processors, the method comprising:
storing sitemap information for the plurality of websites, wherein the sitemap information includes a predicted update period for each respective website in the plurality of websites identified by the sitemap information;
storing index information for each website in the plurality of websites in an index data store, wherein,
a first website in the plurality of websites is hosted by an external system,
the first website comprises a plurality of inter-referenced webpages, and
the index information includes an index of the first website that comprises an index of each webpage in the plurality of inter-referenced webpages;
responsive to an update of at least one webpage in the plurality of inter-referenced webpages of the first website by the external system:
(a) receiving an update request to index the website from the external system, wherein the request to index identifies a subset of webpages in the plurality of inter-referenced webpages that have been updated, and
(b) updating the stored sitemap information to identify each of the webpages in the subset of webpages of the first website that have been updated as not current;
analyzing the stored sitemap information to identify a webpage of a website in the plurality of websites as having index information in the index data store that is at least potentially out of date, wherein the analyzing selects the subset of webpages in the first website that have been updated; and
scheduling webpages for crawling in accordance with the analyzing of the stored sitemap information.

5. The method of claim 4, wherein the sitemap information includes a predicted update period for each respective webpage of each respective website in the plurality of websites identified by the sitemap information.

6. The method of claim 4, wherein the sitemap information includes last modification dates for at least a subset of websites; and wherein at least some of the webpages scheduled for crawling are scheduled in accordance with the last modification dates of their corresponding websites.

7. A method of maintaining an index of a website, wherein the website comprises a plurality of inter-referenced webpages, the method performed on a computer system having one or more processors and memory storing one or more programs for execution by the one or more processors, the method comprising:
updating at least one webpage in the plurality of inter-referenced webpages of the website;
indexing, responsive to the updating, the entire first website, wherein the indexing takes into account the update to the at least one webpage and wherein the indexing is performed by a curator of the first website; and
communicating the index to a remote system responsible for indexing a plurality of websites that is not associated with the curator.

8. The method of claim 7, wherein
the indexing forms a current index for the website, and wherein the indexing further comprises comparing data of a prior indexing of the website to the current index of the website thereby identifying one or more subsets of the current index that are different as compared to the prior indexing, the one or more subsets of the current index corresponding to the at least one webpage that has been updated, and wherein
the communicating the index communicates just those portions of the current index which got changed to the remote system responsible for indexing the plurality of websites.

9. A method of maintaining an index of a website, wherein the website comprises a plurality of inter-referenced webpages, the method performed on a computer system having one or more processors and memory storing one or more programs for execution by the one or more processors, the method comprising:
updating a component of at least one webpage in the plurality of inter-referenced webpages of the website;
determining, responsive to the updating, which webpages in the plurality of inter-referenced webpages are modified by the updating of the component, wherein the webpages in the plurality of inter-referenced webpages that are modified by the updating of the component constitute a subset of the webpages in the plurality of inter-referenced webpages; and
communicating a request to index to a remote or internal system responsible for indexing a plurality of websites, wherein the request to index includes a request to index each webpage in the subset of webpages and does not include a request to index webpages in the plurality of inter-referenced webpages that are not in the subset of webpages.

10. A system for displaying a user interface that displays content aggregated from a plurality of sources in a single window, wherein the system comprises a memory and one or more processors, wherein the memory comprises nontransistory instructions that encode a method, wherein the method comprises:
hosting a plurality of user communication channels wherein the plurality of user communication channels is selected from a combination of one or more e-mail channels, one or more news channels, one or more social networks, one or more link services, one or more messengers, and one or more video transmission/holding services, wherein the hosting represents the plurality of user communication channels in a single window in a user interface; and
responsive to receiving an update from any user communication channel in the plurality of user communication channels, presenting in a uniform format the update in the single window that provide the user with a notification regarding the update within the window.

11. The system of claim 10, wherein the plurality of user communication channels comprises a plurality of e-mail channels (accounts).

12. The system of claim 10, wherein the plurality of user communication channels comprises one or more e-mail channels and one or more social networks.

13. The system of claim 10, wherein the method enables the user to carry out all incoming and/or outgoing interactions across the plurality of user communication channels as if a separate client or application was being used for each respective communication channel, and wherein the method further provides:
user selection to make visible only messages/updates from all or a subset of the plurality of communication channels, and
user selection to select or sort aggregated messages/updates from the plurality of communication channels by a plurality of ways including creation time or communication channel identity.

14. The system of claim 10, wherein the plurality of user communication channels includes a plurality of email accounts and wherein the method further comprises:
aggregating and displaying emails from the plurality of email accounts in the single user window without downloading the emails, wherein email messages from the plurality of email accounts are ordered in the single user window according to their incoming date and time, or according to the email address of senders of the email messages, and wherein the method further allows the user to read the emails, extract attached files from the emails, and respond to the a respective email via the corresponding email account in the plurality of email accounts through which the respective email was received, or through any of the other email accounts in the plurality of email accounts.

15. The system of claim 14, wherein the method further categorizes emails received from the plurality of email accounts together.

16. The system of claim 14, wherein the categorization of the emails includes grouping together emails from all or selected email accounts in plurality of email accounts by received emails, sent emails, spam emails, and emails received by pre-specified senders.
